(19) United States
(12) Patent Application Publication
(10) Pub. No.: US 2006/0269808 A1
(43) Pub. Date: Nov. 30, 2006

(54) Electrochemical generator

(76) Inventors: Luca Merlo, Montorfano (IT); Daniele Facchi, Rovato (IT); Antonio Maggiore, Milano (IT); Giuseppe Faita, Novara (IT)

Correspondence Address: HEDMAN & COSTIGAN P.C., 1185 AVENUE OF THE AMERICAS, NEW YORK, NY, 10036, US

(21) Appl. No.: 10/573,003

(22) PCT Filed: Oct. 14, 2004
(86) PCT No.: PCT/EP04/11568

§ 371 Date: Mar. 21, 2006

(30) Foreign Application Priority Data
Oct. 14, 2003 (IT) MI2003A001972

(51) Int. Cl. H01M 8/04; H01M 8/10; H01M 8/02; H01M 2/08

(52) U.S. Cl. 429/26; 429/32; 429/38; 429/35

(57) ABSTRACT

The invention describes a new design of ionomer membrane fuel cell stack comprising a multiplicity of stainless steel bipolar plates, electrodes, membranes and perimetrical sealing gaskets enclosed between compression plates. The novel design is directed to prevent the build up of metal ions in the membranes and the consequent voltage decay; for this purpose, the lateral migration inside the ionomer membranes of the metal ions contained in the cooling fluid is prevented.

### FIELD OF THE INVENTION

The invention is relative to an electrochemical generator of electrical energy, and in particular to a polymer membrane fuel cell stack.

### DESCRIPTION OF THE PRIOR ART

Fuel cells are long-time known as devices for the direct conversion of the chemical energy of combination of a fuel such as hydrogen and an oxidant such as air into electrical energy. Fuel cells are not subject to the known limitation of Carnot's cycle and are hence characterised by a particularly high efficiency compared to that of the conventional electrical energy production devices in which an intermediate thermal stage is present.

Among the various known types, the ionomer ion-exchange membrane fuel cell (hereafter PEMFC from Proton Exchange Membrane Fuel Cell) has gained a special attention for its capability to respond to quick power demands and for the simplicity of the associated auxiliary systems, particularly in automotive applications and in the generation of small stationary power for domestic appliances or for small communities.

The PEMFC consists of an electrochemical unit, typically suited to be laminated with other equivalent ones according to a filter-press type modular arrangement commonly called a stack. A PEMFC in general comprises an ionomer membrane (of the perfluorinated type as known in the art, for instance commercialised by DuPont, USA under the trade-mark Nafion®, or of the hydrocarbon type derived from polymers such as polystyrene or polyetheretherketones), on whose faces are applied two electrodes, a negative anode and a positive cathode, in form of porous films containing suitable catalysts. The external surfaces of the electrodes are in contact, in their turn, with generally planar porous structures suitable for establishing an optimal electrical conduction and a homogeneous distribution of the reactants, for instance hydrogen and air, indifferently known, due to this dual function, as collectors or distributors. The overall assembly resulting from the electrochemical unit associated with the collectors (hereafter defined with the acronym MEA from Membrane-Electrode Assembly) is finally enclosed between a pair of bipolar plates, consisting of two appropriately shaped sheets, impervious toward the reactants and electrically conductive. The fuel and the oxidant are supplied through suitable openings obtained in the bipolar plates and are distributed respectively to the anode and the cathode through the collectors. The fuel, for example hydrogen, is oxidised with generation of protons and electrons. Protons migrate across the ionomer membrane and participate to the cathodic oxygen reduction reaction with formation of water. The electrons required by the reduction reaction come from the anode through an external circuit. The conversion efficiency of the chemical energy of reaction into electrical energy, although substantially higher than that of the conventional generators, is largely below 100%: the portion of chemical energy which is not converted to electricity is dissipated as thermal energy which must be withdrawn with an adequate cooling device in order to maintain the internal cell temperature typically around 60-100° C. The cooling device is preferably of the forced-air type for the small power systems and with demineralised water circulation for the higher power systems, for the sake of higher compactness. The cooling is carried out, for instance, by making the water flow along one of the bipolar plates which thus consists of a double-walled hollow shell. A further necessary measure to ensure the regular functioning of the PEMFC is given by the pre-humidification of the reactants. The purpose of the pre-humidification is to feed the PEMFC with a certain amount of water useful to maintain the membrane hydration at the maximum level, to which corresponds the highest proton migration capacity and thus the lowest ohmic resistance and the highest operating voltage.

According to the prior art, the bipolar plates delimiting the cells can be manufactured out of graphite or more generally out of graphite-polymer binder composites. In a largely preferred alternative, they can also be made of metal, preferably stainless steel of the chromium/nickel/molybdenum family. The stray currents caused by the high voltages localised in the stack internal manifolds crossed by water induce in this case some corrosion of the stainless steel, localised in particular on the plate surfaces coming in contact with the cooling water. Such corrosion, which is usually not so intense as to provoke structural damages to the bipolar plates, leads anyway to a progressive enrichment in metal ions, essentially Ni⁺⁺, Cr⁺⁺⁺ and Fe⁺⁺⁺ ions in the circulating water. This enrichment may be limited by introducing a cation exchange resin-containing filter in the cooling water circuit, whose operation introduces however some operative complications in the overall system. As an alternative, it is possible to strongly reduce the metal ion release by employing high-alloy stainless steels endowed with a higher corrosion resistance. The high-alloy steels, characterised by high chromium, nickel and molybdenum content, are nevertheless expensive and substantially increase the investment required for the stack manufacturing. Metal ions are also released by auxiliary components of the overall system, such as the resin filter container, the collecting tanks of the circulating water, the required heat exchangers, the various piping and the control sensors. These components, however, are not subject to the stack high voltages which sensibly accelerate the dissolution of metals: therefore their contribution to ion enrichment in the circulating water is usually negligible. It is worthwhile recalling that the accelerated release and metal ion enrichment mechanisms are partially effective also in the stack manifolds crossed by the reactant gases and exhausts with variable intensity, depending on the extension of the regions wherein liquid water is separated.

Graphite, although being subject as well to chemical attack by stray currents, generates carbon dioxide as the corrosion product hence giving not rise to metal ion enrichment if not at a minimum level corresponding to its content in impurities. This doubtless advantage is nevertheless more than balanced by the reduced thickness of the bipolar plates obtainable with stainless steel, for instance 0.1-0.5 mm, allowing the manufacturing of much more compact stacks having the high resilience which is typical of metals, ensuring in general a particularly satisfactory mechanical and thermal shock resistance.

It has been observed that the stacks manufactured with stainless steel bipolar plates show a performance decay of the terminal cells after variable operating times, of the order of 200-300 hours. Such a decay has been attributed to the higher thermal dispersion characterising the terminal cells, whose temperature may therefore be lower than the average of the cells in the stack. The lower temperature determines an excessive condensation of the water vapour contained in the reactant gases, from which ensues the flooding of the catalytic film porosity. The presence of liquid water in the pores of the catalytic films hinders the diffusion of the reactant gases towards the sites of reaction located at the interface with the ionomer membrane. It has therefore been proposed to insert a heating element in contact with the outward surface of each terminal cell: with an appropriate control device, it is possible to increase the terminal cell temperature so that it coincides with the average temperature of the remaining cells of the stack.

An alternative kind of modification consists of putting a suitable thermal device consisting of a hollow shell crossed by circulating water in contact with the external surface of each terminal cell, in accordance with a construction equivalent to that adopted for the cooling of the single cells: by suitably adjusting the circulating water temperature, it is possible to maintain the terminal cell temperature at a level sufficient to prevent a harmful condensation of water vapour.

A further proposal of performance decay mechanism is based on the inhomogeneous electrical current distribution within the terminal cells: as a solution, an enlarged sizing of the contacts to the external electric circuit has been proposed. The inventors have verified however that the improving techniques of the prior art are only able to delay the onset of the stack performance decay up to 500-1000 hours of operation. In particular, the inventors observed that after this improved period of operation a new type of performance decay appears, limited to a few cells located at the stack extremity on the negative terminal side. Surprisingly, the performances of the cells located at the extremity on the positive terminal side, as well as those of the remaining cells of the stack, remain unvaried at entirely satisfactory levels. The performance decay appears as a progressive decrease in the cell voltages which in the terminal phase undergo an extremely destructive inversion of polarity. To prevent this serious situation, it is mandatory to monitor the cells, providing for short-circuiting those whose voltages result decreased below a predetermined critical value in a timely fashion. It has also been noticed that short-circuiting tends to worsen the decay of the adjacent cells.

The fact that these problems arise on a longer term, also in stacks provided with heating devices for the terminal cells, that the decay is worsened in the adjacent cells upon short-circuiting and that the decay occurs only on the stack negative terminal side clearly indicates that the failure analysis of the prior art is certainly not applicable to the kind of decay observed by the inventors. Thus, it can be concluded that the prior art cannot explain and solve the long term decay in the performances of the cells near the negative terminal side of a stack manufactured with stainless steel bipolar plates.

It is an object of the present invention to provide a design of a stack of cells manufactured with stainless steel plates overcoming the limitations of the prior art, preventing the decay of the cells located in proximity of the stack negative terminal.

### DESCRIPTION OF THE INVENTION

Under one aspect, the invention consists of the design of a stack manufactured with metal bipolar plates by means of which the lateral migration inside the ionomer membranes of metal ions contained in the cooling fluid is prevented.

In a preferred embodiment, the invention consists of the design of a stack manufactured with stainless steel bipolar plates, preferably of the AISI 316 L type (DIN X 2 CrNiMo 1712 or 1713, 16-18% chromium/10-14% nickel/2-3% molybdenum), according to which the migration of metal ions towards the membrane is prevented making use of ionomer membranes having reduced peripheral dimensions. In particular, the perimeter must result localised in an intermediate region of the perimetrical sealing gaskets comprised between the edge of the active area and the circumference of the cooling water feed and discharge holes. As an alternative, for the construction material the use of molybdenum-free stainless steels with higher nickel and chromium content is preferred, such as those of the series CrNi 2520 according to the DIN standards (19-22% Ni, 24-26% Cr). In another preferred embodiment, the lateral migration of metal ions towards the membrane active area is hindered by employing ionomer membranes with dimensions equalling those of the bipolar plates and with the periphery of the feed and discharge holes of water and optionally of the reactant and exhausts gases being provided with non conductive material preferably having elastic characteristics, applied in form of planar gaskets, 0-rings or curable liquid film.

In a further preferred embodiment, the present invention solves the problem of metal ion migration towards the membrane active area by homogenising the electric field within the cooling water injection and discharge manifolds on the stack negative terminal side, upon installation of a bipolar plate free of feed holes as the external bipolar plate of the last cell.

The invention will be described hereafter resorting to the attached figures, having a merely exemplifying and not limiting function.

### BRIEF DESCRIPTION OF THE DRAWINGS

FIG. 1 shows a schematic cross-section of a PEMFC stack according to the prior art;

FIG. 2 shows separately the different components of the first cell of the stack of FIG. 1;

FIG. 3 shows separately the different components of the first cell of a stack relative to a first embodiment of the invention;

FIG. 4 shows separately the different components of the first cell of a stack relative to a second embodiment of the invention;

FIG. 5 shows the stray current distribution in the stack of FIGS. 3 and 4;

FIG. 6 shows separately the different components of the first cell of a stack relative to a third embodiment of the invention;

FIG. 7 shows the stray current distribution in the stack of FIG. 6.

### DETAILED DESCRIPTION OF THE DRAWINGS

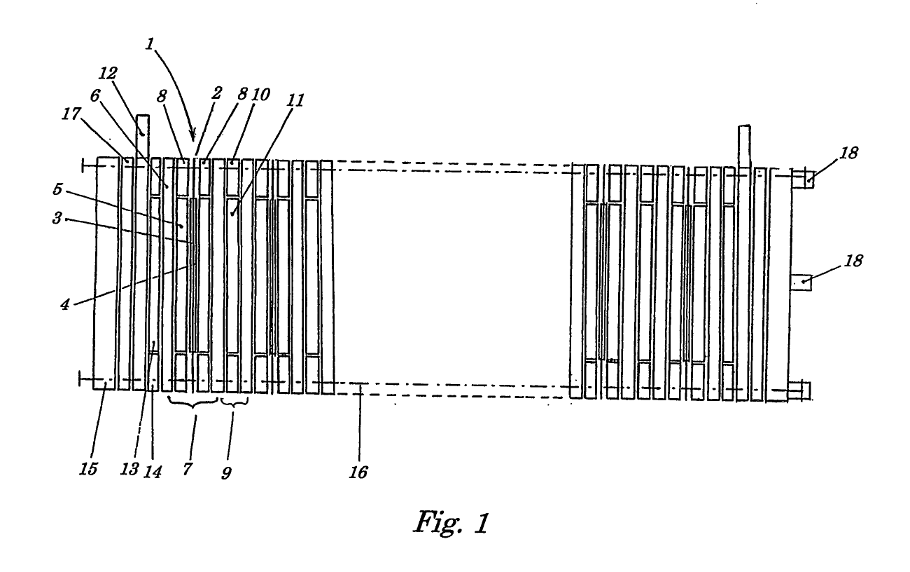

With reference to the prior art, for instance represented by U.S. Pat. No. 5,482,792, FIG. 1 shows a longitudinal section of a PEMFC stack wherein (1) identifies the MEA assemblies each containing the ionomer membranes (2), the anodes (3), the cathodes (4) and the collectors (5), (6) the bipolar plates, (7) the single cells each comprising a MEA unit (1) enclosed between two bipolar plates (6) provided with perimetrical sealing gaskets (8), (9) the cooling devices consisting of a shell fed with demineralised water, delimited by two adjacent bipolar plates (6), provided with peripheral sealing gaskets (10) and containing a conductive spacer (11) directed to maintain the longitudinal electrical continuity between the two adjacent bipolar plates, (12) two sheets of electrically conductive material for the connection of the stack to the external electrical circuit, each in contact with the terminal bipolar plates through a conductive element (13) insulated from the external environment by means of a gasket (14). Moreover, (15) indicates two plates of low flexibility which permit to maintain the multiplicity of cell (7) and the cooling devices (9) under compression, ensuring a low contact electrical resistance under the action of tie-rods (16) provided with a non conductive coating and distributed in an appropriate number along the perimeter of the plates (15), of the bipolar plates (6), of the sheets (12) and of the gaskets (8), (10) and (14), optionally provided with springs (not shown in the figure) for compensating the thermal dilatations/contractions of the stack components, (17) a sheet of non conductive material for the electrical insulation of the stack plates (15), (18) the connections, located on the plate (15) on the positive terminal side of the stack, to the external circuits for feeding fuel and oxidant gas, for instance hydrogen and air, for extracting the residual gases and the product water, and for injecting and discharging the cooling water. The fuel and the oxidant, proceeding from the external circuits through the connections (18), are supplied respectively to the anodes and the cathodes by means of distribution channels for example obtained in the thickness of the gaskets (8) and connected to longitudinal manifolds formed in the stack by the juxtaposition of suitable holes in the various components. In an equivalent fashion, the cooling water is injected into the devices (9), the residual gases mixed with product water are extracted and the cooling water is discharged.

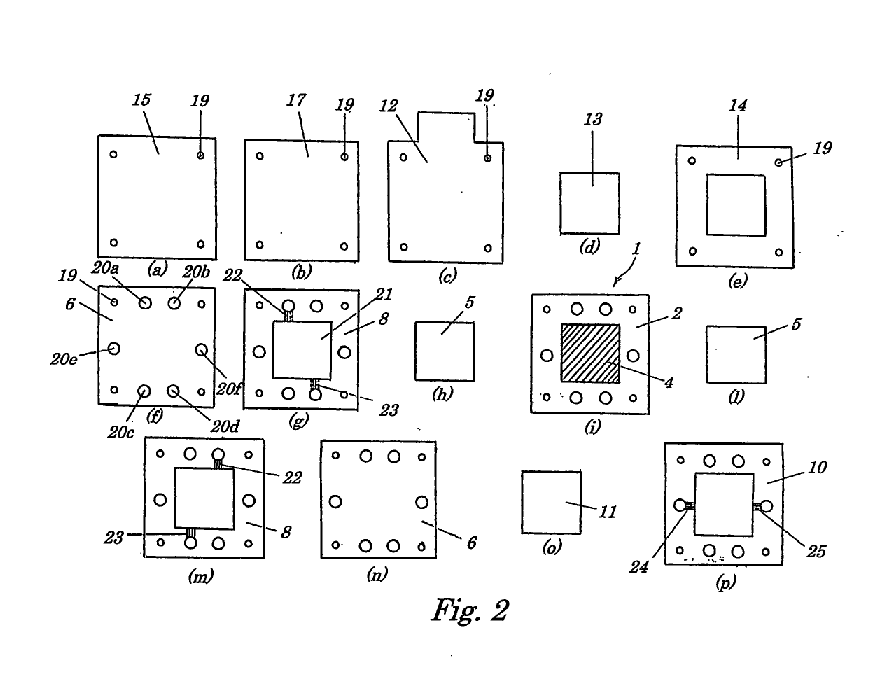

For a better understanding, the components of the first cell located on the negative terminal side and of the relevant cooling device are shown in FIG. 2, in a succession from (a) to (p) corresponding to the lamination sequence. In particular: (a) represents schematically the front-view of the compression plate (15) with the relevant holes (19) for the passage of tie-rods (16), (b) the sheet of non conductive material (17) preferably having elastic characteristics, for instance EPDM rubber, directed to ensure the electrical insulation of the plate (15) of the stack and also provided with holes (19) for the passage of tie-rods (16), (c) the connecting sheet (12) of highly conductive material, such as aluminium or copper, optionally provided with a coating suitable for preventing an increase of the contact electrical resistance in time, for instance a silver plating, provided as well with holes (19), (d) the conductive element (13) having the same size as the cell active area, having residual deformability and elasticity in order to achieve a complete contact between sheet (12) and first bipolar plate (6) also in the presence of small surface irregularities or small deflections, (e) the gasket (14) directed to insulate the space containing the element (13) from the external environment to prevent a possible deterioration in the quality of the contact as a consequence of processes of oxidation due to oxygen and to the moisture contained in the air. In (f) it is shown a front-view of the first bipolar plate (6), wherein with (20a) and (20b) are indicated the holes directed to feed the fuel and oxidant gases, with (20c) and (20d) the fuel and oxidant exhaust extraction holes, with (20e) and (20f) the cooling water injection and discharge holes and finally with (19) the holes for the passage of tie-rods (16). It is to be noticed how just in correspondence of the annular surfaces of holes (20e) and (20f), in contact with the cooling water, the corrosion phenomena leading to the decay of cells disposed in the proximity of the stack negative terminal are specifically localised, as will be explained more in detail hereafter. Holes (19) and from (20a) to (20f) also appear in the first perimetrical sealing gasket (8), sketched in FIG. 2g, wherein the central hollow portion (21) defines the site of the first collector (5) illustrated in FIG. 2h again as a front-view. The face of the gasket of FIG. 2g opposite the observer is put in contact with the first bipolar plate and is provided, besides the indicated holes, of distributing channels (22) and (23) obtained in the thickness and indicated with dashed lines. The distributing channels (22) and (23) put in communication respectively the holes (20a) and (20d) with the central portion (21) of the gasket wherein the first collector (5) is housed, in contact in its turn with the first of the porous catalytic films applied to the membrane surfaces. In this way the fuel gas, for instance hydrogen, is supplied to the collector and thence distributed over the catalytic porous film. The exhaust gas is discharged from hole (20d), optionally together with water. In FIG. 2i a membrane is sketched with a catalytic porous film having the same dimensions of the collectors (5) and of the hollow central portion (21) of the sealing perimetrical gaskets (8) applied on the central part of both faces (active area, only one of which is visible). In FIG. 2m the second perimetrical sealing gasket (8) is represented, provided with holes (19) and from (20a) to (20f) as already seen in the case of the first gasket.

The face of the second perimetrical gasket (8) of FIG. 2l facing the observer is placed in directed contact with the second bipolar plate (6) and is provided with distributing channels (22) and (23), totally equivalent to those seen for the first gasket, but off-set therefrom (represented by a continuous line): the channels in fact connect the holes (20b) and (20c) to the central portion (2l) of the second perimetrical gasket containing the second collector (5) (sketched in FIG. 21), in contact with the second catalytic porous film applied to the membrane. In this way the oxidant gas, for instance air, is fed through the channels (22) to the second collector and thence distributed over the second catalytic porous film. The residual oxidant gas, mixed to the product water, is discharged through the channels (23) in the extraction hole (20c).

In FIG. 2n a front-view of the second bipolar plate (6) is shown, totally equivalent to the first bipolar plate of FIG. 2f. FIGS. 2o and 2p finally represent the conductive spacer (11) and the sealing peripheral gasket (10) of the cooling device. The gasket (10) in particular is provided with cooling water injection and discharge channels (24) and (25).

The lamination of the elements from FIG. 2f to FIG. 2p gives rise to a repetitive module constituting a single cell with the relevant cooling device. The stack of FIG. 1 consists of a multiplicity of repetitive modules, enclosed between the two compression plates (15) and the two connecting sheets (12): the overlaying of the various holes from (20a) to (20f) determines the formation of longitudinal manifolds, each provided with a connection (18) for the coupling to the external circuits and each, depending on its function, respectively in communication with the anodes or the cathodes or the cooling devices.

The above description makes clear that the longitudinal manifolds formed by the overlaying of the holes (20e) and (20f) in the normal operating conditions are completely filled with the circulating cooling water which, depending on the level of conductivity and under the effect of the high electrical voltage resulting from the sum of the voltages of the various cells, permits the passage of a stronger or weaker electrical current, known as parasite or stray current. This current, which practically represents a loss of electrical efficiency, is minimised by demineralising the cooling water. It is not possible to reduce the stray currents to zero since the circulating water always maintains a certain conductivity due to the incomplete efficiency of the demineralisation and to the enrichment with ions of various origin. A similar situation may occur also in the reactant and exhaust passages formed by the overlaying of holes (20a), (20b), (20c) and (20d): in this case the conditions for the passage of small stray currents are generated by the presence of water in the liquid state formed by condensation of the humidification vapour occasioned by the stack thermal dispersions to the external environment and by separation of product water from the residual gases.

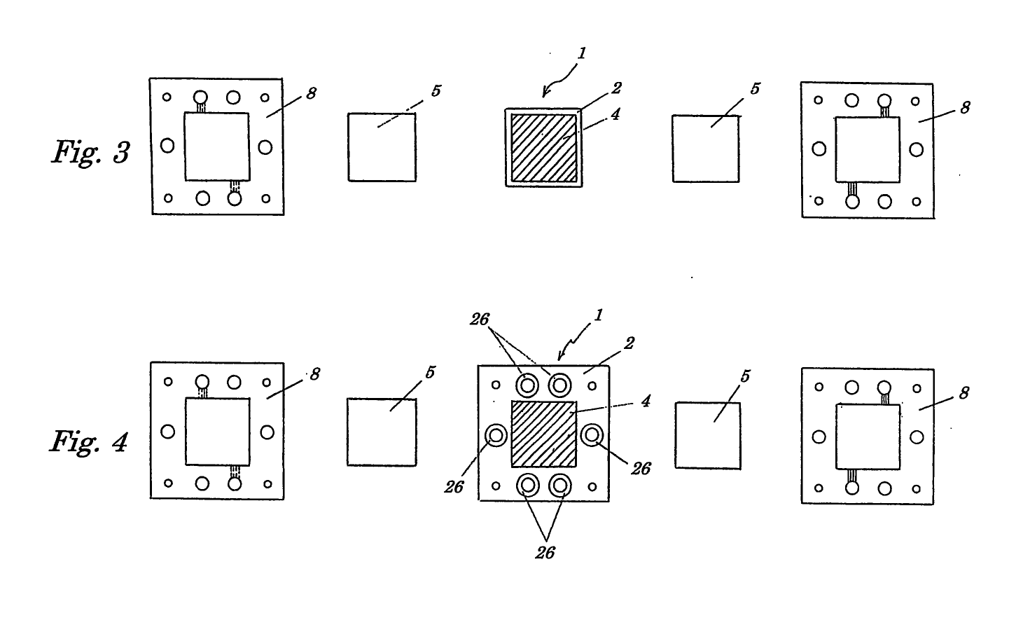

FIG. 3 shows a first embodiment of the invention, wherein the common parts to those of the case in FIG. 2 are indicated with the same reference numerals. (2) indicates the ionomer membrane whose perimeter is located in a region of the perimetrical sealing gasket surface comprised between the edge of the active area and the circumference of the feed, injection, extraction and discharge holes. This region may be planar on the face contacting the membrane and therefore opposite the face containing the distributing channels (22), (23), (24) and (25): as an alternative, it may be provided with one or more ridges or rings with the purpose of preventing both the leakage of the gases, the product water and the cooling water to the external environment, and the contact of the cooling water with the membrane edge in a safer way.

FIG. 4 shows the components of the single cell of a second embodiment of the invention wherein the unvaried parts with respect to those of FIG. 2 bear the same reference numerals. (2) indicates the ionomer membrane whose perimeter coincides with that of the bipolar plates, provided with feed, injection, extraction and discharge holes of bigger section than the equivalent holes in the gaskets. The periphery of the holes in the membranes is provided with planar rings (26), for instance made of EPDM. EPM rubbers and in general low hardness polymeric materials with elastic characteristics can be employed as well. The purpose of the rings (26) is to seal the interface of each pair of sealing gaskets in correspondence of the holes in order to prevent the possibility both of the leakage of gas, product water and cooling water to the outside, and of the contact between cooling water and membranes. As an alternative, the planar rings can be replaced by O-rings. As a further alternative, in the region of the perimetrical sealing gaskets delimited by the circumferences of the holes in the membrane and of the holes in the perimetrical gaskets, it is applied a film of liquid material which can be cured and polymerised either by means of a catalyst, or by UV irradiation or thermal treatment. A suitable material is given by liquid silicon resins, which maintain a low hardness and a good elasticity also after completing the curing process. As an alternative to the planar rings, O-rings or cured polymeric film, suitable lips or steps can be provided as known in the art.

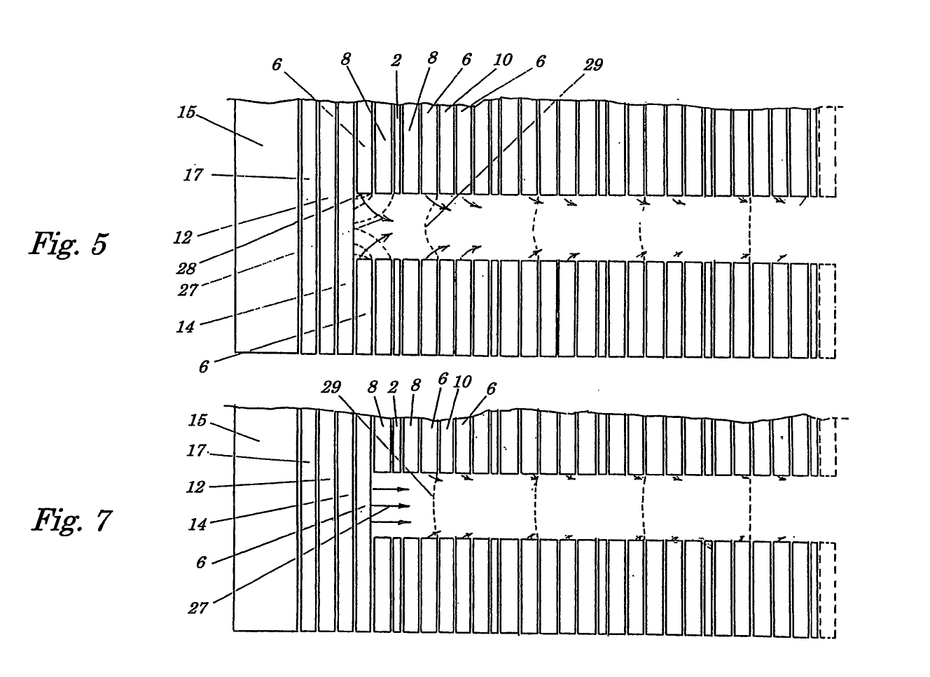

FIG. 5 shows a scheme of distribution, both in the radial and in the longitudinal direction, of the stray currents emitted by the annular surfaces of the holes of each bipolar plate along a longitudinal section, on the negative terminal side of the stack, of one of the manifolds formed by the ordered overlaying of the appropriate holes (20e) and (20f) present on the bipolar plates, the gaskets and the membranes, relative to the stacks of FIGS. 3 and 4: (27) indicates the stray currents emitted by the annular surfaces (28) of the holes in the bipolar plates in contact with the cooling water and (29) the resulting equipotential surfaces, the remaining components being indicated with the same reference numerals as in the previous figures.

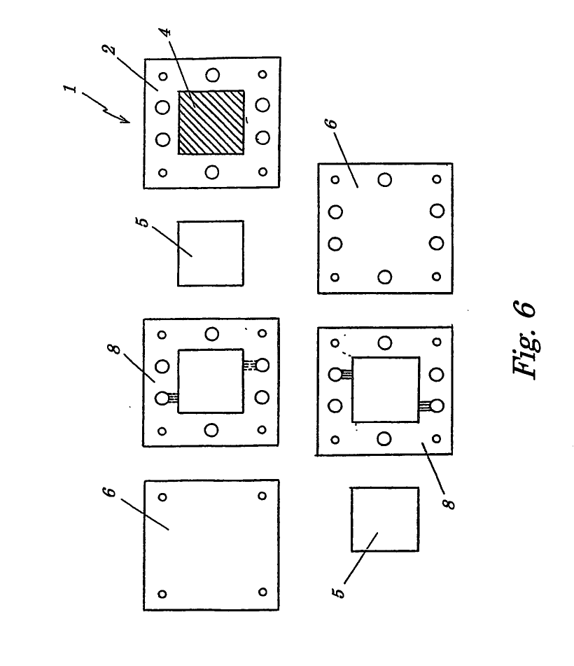

FIG. 6 shows the components of the first cell on the negative terminal side of a third embodiment of the invention, characterised by having the first bipolar plate on the negative side completely free of feed, injection, extraction and discharge holes for the gaseous reactants and exhausts and for the cooling water.

FIG. 7 shows a scheme of distribution, in the radial and in the longitudinal direction, of the stray currents relative to the stack of FIG. 6.

### EXAMPLE 1

The inventors, in the attempt of solving the problem of performance decay of cells located on the negative terminal side of the stacks manufactured with stainless steel bipolar plates, have carried out a series of tests making use of stacks of the type illustrated in FIG. 1, consisting of a multiplicity of fifty cells intercalated with an equal number of demineralised water-fed cooling devices. The stainless steel employed was of the type denominated AISI 316L (DIN X2CrNiMo17 13 2, 16-18% chromium/10-14% nickel/2-3% molybdenum, carbon≦0.03%, minor percentages of silicon and manganese, balance iron). As the ionomer membrane, the Nafion 112 type, provided by DuPont, USA, was invariably used. The catalytic porous films were provided by E-TEK Division, De Nora North America, USA and contained an amount of 1 mg/cm² of platinum.

Metallic reticulated materials coated with a chemically resistant chromium layer were employed as the collectors as disclosed in U.S. Pat. No. 5,482,792.

The stacks employed in the tests were differentiated in their internal design as indicated below:

stack A (reference according to the prior art): components as indicated in FIG. 2.

In particular, the membrane dimensions coincide with those of the bipolar plates and are provided with feed, injection, extraction and discharge holes that can be exactly overlaid to the equivalent holes present on the bipolar plates and the perimetrical sealing gaskets.

stack B (first embodiment of the invention): components of single cells as shown in FIG. 3.

stack C (second embodiment of the invention): components of single cells as shown in FIG. 4.

Of the two sizes adopted for the membranes, the one relative to stack B has certainly the advantage of reducing the amount of employed material, which is particularly expensive. On the other hand, the membrane size employed in stack C is probably more compatible with the automated stack assembly procedures, since the perimeter coinciding with that of the bipolar plates and of the perimetrical sealing gaskets allows a quick and precise centring.

The three stacks were provided with elements equivalent to the cooling devices inserted between the electrical connection plates and each of the two external cells on the negative and positive terminal side in order to maintain their temperature to values close to the remaining cells.

The three stacks were operated at a temperature of 70° C., measured at the residual gas outlet, with a feed of pure hydrogen (1.3 bar absolute, pre-humidification at 70° C., 20% stoichiometric excess) and air (1.2 bar absolute, pre-humidification at 60° C., 50% stoichiometric excess). The current generated on a resistance board corresponded to a density of 0.5 A/cm² referred to the active area. During operation the cell voltages of every stack were monitored, and cells with a voltage≦0.2 Volts were short-circuited (s.c.).

In the following, for each stack are reported the voltages (Volts) of the first eight cells on the negative terminal side, the voltages of the last three cells on the positive terminal side, and the average voltage of the remaining cells.

# Stack A

100 hours [0.70, 0.72, 0.70, 0.69, 0.70, 0.70, 0.71, 0.71] [0.70, 0.72, 0.71] [0.71]

250 hours [0.69, 0.72, 0.70, 0.70, 0.69, 0.71, 0.71, 0.71] [0.70, 0.70, 0.71] [0.71]

500 hours [0.45, 0.55, 0.60, 0.65, 0.69, 0.71, 0.70, 0.71] [0.70, 0.71, 0.70] [0.71]

750 hours [0.20, 0.30, 0.45, 0.55, 0.60, 0.65, 0.70, 0.71] [0.70, 0.71, 0.70] [0.71]

1000 hours [s.c., 0.25, 0.30, 0.40, 0.52, 0.60, 0.65, 0.71] [0.70, 0.71, 0.70] [0.71]

1250 hours [s.c., s.c., s.c., 0.30, 0.40, 0.55, 0.60, 0.67] [0.70, 0.71, 0.70] [0.71]

1500 hours [s.c., s.c., s.c., s.c., 0.30, 0.35, 0.45, 0.55] [0.70, 0.70, 0.71] [0.71]

# Stack B

100 hours [0.70, 0.70, 0.71, 0.69, 0.70, 0.71, 0.70, 0.69] [0.69, 0.71, 0.70] [0.70]

250 hours no significant variation, voltage oscillation≦0.1 Volts

500 hours as above

750 hours as above

1000 hours as above

1250 hours as above

1500 hours as above

# Stack C

100 hours (0.71, 0.69, 0.70, 0.72, 0.70, 0.70, 0.71, 0.71] [0.70, 0.70, 0.71] [0.71]

250 hours no significant variation, voltage oscillation≦0.1 Volts

500 hours as above

1000 hours as above

1250 hours as above

1500 hours as above

The analysis of these data clearly indicates that stacks B and C are virtually immune from performance decay at least for the selected times of testing. Stack A conversely presented a serious instability of the first cells on the negative terminal side after just 500 hours. The voltage decay is progressive and has forced the operators to carry out the short-circuiting (s.c.) when the single cell voltage descended below the critical threshold fixed, as already said, at 0.20 Volts. It is also important to notice that the short-circuiting of cells with a seriously jeopardised voltage accelerated the decay of the nearby cells, with an apparently unstoppable progression toward the centre of the stack. The voltage decay characteristics allow to exclude that the cause originating the problem is the thermal loss to the environment or the current distribution due to non correctly dimensioned connecting sheets to the external electrical circuits as proposed in the prior art analyses. If this were the case, in fact, the problem would be present on the first cell only and in any case at both extremities, negative and positive, of the stack. To clarify the mechanism of the decay occurred on stack A, the inventors carried out a series of checks on the components of both the short-circuited cells and the cells still characterised by a correct functioning. The single most relevant indication was given by the analysis of the membranes, which showed a significant difference in the metal ion content. In table 1 are reported the average nickel and calcium contents detected in the peripheral and central zones of the active areas of the first short-circuited cell on the negative terminal side (PEMFC 1), of a non short-circuited cell close to a short-circuited cell (PEMFC 8) and of a central cell (PEMFC 20):

TABLE 1

| | peripheral zone | central zone |
|---|---|---|
| PEMFC 1 | | |
| Ni (mg/cm²) | 12.9 | 12.7 |
| Ca (mg/cm²) | 0.4 | 0.5 |
| PEMFC 8 | | |
| Ni (mg/cm²) | 11.2 | 0.6 |
| Ca (mg/cm²) | 0.5 | 0.1 |
| PEMFC 20 | | |
| Ni (mg/cm²) | 0.3 | 0.1 |
| Ca (mg/cm²) | 0.1 | 0.1 |

These data clearly indicate that the voltage decay observed on the cells is directly associated with the enrichment of the membranes in metal ions proceeding from the cooling water, as the presence of calcium indicates. In fact the cooling water was characterised by the presence of nickel (7.5 ppm) and of calcium (2 ppm) besides other pollutants among which iron and chromium.

As regards the surprising localisation of the enrichment in the membranes of the cells located at the stack extremity on the negative terminal side, without wishing the present invention to be bound to any particular theory, it may be supposed that the cause resides in the electrical potential profile existing inside the cooling water injection and discharge manifolds.

This profile derives from the radial and longitudinal distribution of the stray currents emitted from the annular surfaces of the holes of each bipolar plate, as schematised in FIG. 5 relatively to the zone adjacent to the stack negative terminal. The current line and potential profile distribution is equivalent in the section of the same manifolds on the positive terminal side of the stack. The current emission peak coincides with the first bipolar plates located in correspondence of the stack negative and positive terminals (longer arrows in FIG. 5) progressively attenuating proceeding toward the centre of the stack (shorter arrows in FIG. 5). The consequent electrical potential distribution is characterised by a substantial uniformity in the manifold region corresponding to the central cells and by a strong asymmetry in the terminal regions. The asymmetry, equivalent from the geometrical standpoint in both of the manifold terminal sections, leads to the formation of a potential gradient which is maximum in correspondence of the negative pole of the cell located at the stack extremity on the negative terminal side, and conversely, in correspondence of the positive polarity of the cell located at the opposite extremity, on the positive terminal side. The combination of the electrical potential inside the manifolds with the voltages of the single cells determines a transversal electrical gradient in the membrane, which on the negative terminal side seems to favour the ionic migration of the cooling water toward the central zone of the membrane, while on the positive terminal side appears to counteract it. In the central part of the manifolds, where the electrical potential distribution is substantially uniform, it would not exist a particular accelerating or retarding action of the migration of the ions, which could hence penetrate inside the membrane mainly by diffusion, which is a much slower process. A similar mechanism of lateral ion penetration inside the membranes in possible in principle also in the manifolds for feeding and extracting the pre-humidified reactant gases and the residual gases containing the product water. However the water condensed from the reactant gases due to the thermal losses is certainly present only as droplets of limited size, provided the pre-humidification is carried out in a correct fashion, and the product water necessarily occupies a small fraction of the extraction manifold section so as not to hinder the release of exhausts. Furthermore, the ion content in the condensed water and in the product water is presumably limited. Therefore the contribution to the ion migration into the membranes is most likely negligible.

### EXAMPLE 2

Taking into account the above outlined hypothesis of membrane ion enrichment mechanism, the inventors assembled a new stack, stack D in the following, equivalent to stack A but for the fact that the first bipolar plate on the negative side was completely free of the feed, injection, extraction and discharge holes for the reactant gases, residual gases and cooling water, as depicted in FIG. 6 which shows the components of the first cell on the negative terminal side of stack D. The remaining components (bipolar plates but for the first, gaskets, MEA units, electrical connecting sheets, compression plates, tie-rods) were entirely equivalent to those employed for the construction of stack A. Stack D was operated in a wholly equivalent fashion to stacks A, B and C. After 1500 hours, no significant decay was observed in the cell voltages, which stayed indistinctly around the average value of 0.71 Volts, with oscillations of about 0.1 Volts. The analysis of the membrane of the first cell on the negative terminal side of the stack showed a negligible ion enrichment, without any particular distinction between peripheral and central zone. Without wishing the present invention to be bound to any particular theory, the inventors have assumed that the presence of a first bipolar plate free of holes modified the electrical potential profile inside the manifolds making it substantially uniform already in the portion in correspondence with the first cell on the negative terminal side of the stack, as indicated in FIG. 7. Therefore, as regards the metal ion enrichment, the cells located on the negative terminal side of the stack are characterised by a behaviour matching the one of the central cells, wherein the manifold electrical potential distribution is physiologically uniform.

Obviously the adoption of a bipolar plate free of holes on the positive terminal side of the stack is not feasible, since the circulation of the cooling water and of the gas reactants and exhausts would be intercepted. Therefore the electrical potential distribution results unvaried and asymmetrical. Nevertheless such a situation is by no means detrimental since, as demonstrated by the testing, the overlapping of the manifold electrical potential with the cell voltages on the positive terminal side of the stack counteracts the migration of metal ions inside the membranes.

The use of a single bipolar plate of different design from the remaining ones does not entail any particular complications for the stack assembly. Furthermore, taking into consideration the necessity of automating the stack assembly as necessarily required by mass production, the solution based on the use of the first bipolar plate of the negative terminal side free of holes is probably preferable to the solutions previously described for stacks B and C.

It is evident that, with water totally free of metal ions, any inconvenience would be eliminated: however with a closed cycle cooling system having metallic parts in contact with the water (bipolar plates under the accelerating effect of the stray currents, the various tubes, the circulating pumps, the control instrumentation, the heat exchangers and the storage tanks), the unavoidable metal ion release leads to a progressive accumulation in the water, which can be countered only partially by the insertion of an ionic-exchange resin-loaded filter. Since the analyses of the circulating water have demonstrated that levels of the order of just a few ppm are sufficient to provoke an unacceptable voltage decay in relatively reduced times, levels at least one order of magnitude lower are probably required to ensure a sufficient functioning stability. Similar levels of metal ion concentration in water are not easy to maintain with ion-exchange resins, unless largely oversized filters are employed with very frequent adsorption/regeneration cycles, two measures which are both incompatible with the cell system management that, on the contrary, has to be as simplified as possible.

As is evident to an expert in the field, the invention may be practised making other variations or modifications to the cited examples.

It is hence to be understood that the foregoing description does not intend to limit the invention, which may be utilised according to different embodiments without departing from the scopes thereof, and whose extent is univocally defined by the appended claims.

In the description and claims of the present application, the word “comprise” and its variations such as “comprising” and “comprises” are not directed to exclude the presence of other elements or further components.

1. A stack consisting of a filter-press modular arrangement comprising a multiplicity of single proton exchange membrane fuel cells and of cooling devices, each cell being delimited by a pair of metal bipolar plates and comprising ion-exchange membranes and perimetrical sealing gaskets shaped as frames suitable for housing current collectors within their hollow central part, the bipolar plates and the gaskets being provided with passage openings comprising holes for feeding the reactant gases, for extracting the residual gases with the reaction products, for injecting and discharging a thermostatting fluid, the lateral migration of ions proceeding from said thermostatting fluid insisde said ion-exchange membranes in prevented.

2. The stack of claim 1 wherein the bipolar plate closest to the negative terminal is free of passage openings.

3. The stack of claim 1 wherein said lateral migration of ions is prevented by means of a physical isolation of the ion-exchange membranes from the thermostatting fluid.

4. The stack of claim 1 claim 1 wherein the construction material of the metal bipolar plates is stainless steel containing 16-26% chromium, 10-22% nickel, and optionally molybdenum.

5. The stack of claim 4 wherein said stainless steel is selected between AISI 316L and the steels of the CrNi 2520 series according to DIN.

6. The stack of claim 1 wherein the thermostatting fluid is demineralised water circulating in a close circuit.

7. The stack of claim 1 wherein the perimeter of the ion-exchange membranes is located in an intermediate region of the perimetrical sealing gaskets comprised between the edge of the central hollow portion and the circumference of the passage openings.

8. The stack of claim 7 wherein the ion-exchange membranes are isolated from the thermostatting fluid by means of sealing elements located in said intermediate region, optionally comprising ridges or rings.

9. The stack of claim 1 wherein the ion-exchange membranes are provided with passage holes matching the passage openings of the gaskets and having a greater section than said openings, which are isolated from the thermostatting fluid by means of sealing elements located between the edges of said passage holes of the membranes and the passage openings of the gaskets optionally comprising ridges or rings of non conductive material in form of planar gaskets or O-rings.

10. The stack of claim 9 wherein said rings of non conductive material are made of low hardness rubbers, optionally EPM or EPDM.

11. The stack of claim 9 wherein said rings of non conductive material consist of a liquid film applied at the moment of assembling the stack and polymerised with a catalyst contained in the liquid film, or by UV irradiation or thermal treatment.

12. The stack of claim 11 wherein said film is provided with elasticity and reduced hardness after polymerisation.

13. The stack of claim 12 wherein said liquid film consists of a silicon resin-based polymerisable material.

14. (canceled)
